(19) United States
(12) Patent Application Publication
(10) Pub. No.: US 2008/0046760 A1
(43) Pub. Date: Feb. 21, 2008

(54) STORAGE DEVICE FOR STORING ENCRYPTED DATA AND CONTROL METHOD THEREOF

(76) Inventor: Yasuaki NAKAZATO, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/769,256

(22) Filed: Jun. 27, 2007

(30) Foreign Application Priority Data
Jun. 30, 2006 (JP) 2006-182436

(51) Int. Cl. H04L 9/00; G06F 12/14

(52) U.S. Cl. 713/193; 726/26

(57) ABSTRACT

A storage device includes a secure region including a plurality of pages. Each of a plurality of pages includes a first storage region in which a plurality of data items is stored and a second storage region in which a plurality of identification data items corresponding respectively to the plurality of data items is stored.

### CROSS-REFERENCE TO RELATED APPLICATIONS

This application is based upon and claims the benefit of priority from prior Japanese Patent Application No. 2006-182436, filed Jun. 30, 2006, the entire contents of which are incorporated herein by reference.

### BACKGROUND OF THE INVENTION

1. Field of the Invention

The present invention relates to a storage device such as a memory card including, for example, a NAND-type flash memory, and in particular to a storage device which handles encrypted data and a control method thereof.

2. Description of the Related Art

For example, in a memory card using a NAND-type flash memory, a technique which handles encrypted data between a host device (hereinafter, simply called a “host”) and the memory card to maintain high security has been developed. In this case, media key block (MKB) data is stored in the memory card. MKB is the data which are necessary to generate a title key when a host begins to read data from a secure region and writes in data at the secure region. When the host accesses the memory card, the access is controlled by this MKB. Further, in one memory card, a plurality of MKBs is stored, and identification data (hereinafter called an “MKB ID”) for identifying these MKBs is used.

When data is written to the memory card from the host, it is generally transferred to the memory card in units of 512 bytes. The same is true in a case of writing data in a secure region of the memory card, namely, encrypted data in units of 512 bytes is transferred to the memory card from the host. Access to the secure region is controlled by the MKB. Therefore, the MKB ID is allocated with respect to each data write of 512 bytes, and the MKB corresponding to this MKB ID is transferred to the host from the memory card. Based upon this MKB, predetermined processing is performed so that a key is produced, and data is encrypted using this key and transferred to the memory card. The data transferred to the memory card and the MKB ID corresponding to the data are managed within the secure region of the NAND-type flash memory.

Conventionally, when the MKB ID is written to the NAND-type flash memory, a one-byte region is added with respect to each data unit of 512 bytes to write the MKB ID in this one-byte region. That is, four pairs of 512-byte data units and the one-byte MKB ID are written to one page of the NAND-type flash memory. In other words, data and MKB IDs are alternately stored within one page.

Further, since the MKB ID is one data item representing 0 to 15, it consists of four bits. Therefore, four bits are sufficient to store the MKB ID, so that the remaining four bits in the one-byte region are wasted.

Therefore, there has been a desire for the development of a storage device in which a storage region can be reduced by centrally managing identification data corresponding to data which is stored in the secure region in a specific region within one page, and a control method thereof.

Incidentally, by using a low-cost storage medium, a technique which is capable of realizing high security between the storage medium and a storage device which stores reproduced content in this storage medium has been developed (for example, see Jpn. Pat. Appln. KOKAI Publication No. 2000-357213).

### BRIEF SUMMARY OF THE INVENTION

According to a first aspect of the invention, there is provided a storage device comprising: a secure region including a plurality of pages, wherein each of the plurality of pages includes a first storage region in which a plurality of data items is stored and a second storage region in which a plurality of identification data items respectively corresponding to the plurality of data items is stored.

According to a second aspect of the invention, there is provided a storage device comprising: a storage unit including a secure region in which a plurality of data items is stored, the securing region comprising a plurality of pages; and a controller which causes one of the plurality of pages to store a plurality of data items, the controller causing a specific region of the page to store a plurality of identification data items respectively corresponding to the plurality of data items.

According to a third aspect of the invention, there is provided a control method of a storage device comprising: causing a first page in a secure region of a storage unit to store a plurality of data items, and causing a specific region of the first page to store a plurality of identification data items respectively corresponding to the plurality of data items.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing an arrangement relationship between the data items and the MKB IDs within one page according to this embodiment;

FIG. 2 is diagram schematically showing a memory card and a host applied to this embodiment;

FIG. 3 is a view schematically showing a configuration of the memory card applied to the embodiment;

FIG. 4 is a flowchart schematically showing a data write operation according to the embodiment; and

FIG. 5 shows the data write operation according to the embodiment, and is a view schematically showing a relationship between a plurality of data items stored within one page and MKB IDs.

### DETAILED DESCRIPTION OF THE INVENTION

Hereinafter, an embodiment of the present invention will be explained with reference to the drawings.

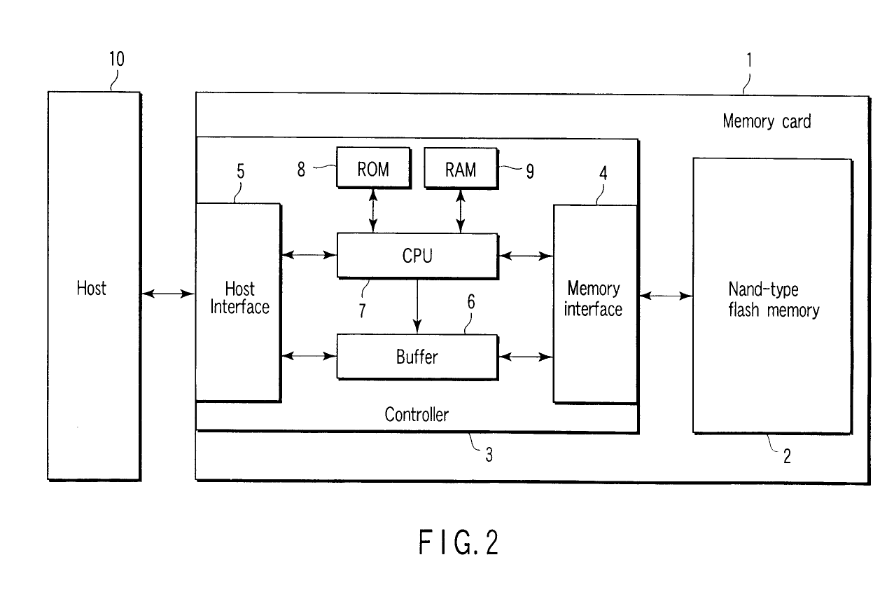

FIG. 2 shows an example of a storage device to which the embodiment is applied, for example, a memory card. In FIG. 2, a host device (hereinafter called “host”) 10 is provided with a hardware and software (system) for accessing a memory card to be connected. This host 10 accesses a memory card 1 to perform data reading, data writing, data erasing, and the like.

When connected to the host 10, the memory card 1 is supplied with power to operate and perform processing according to access from the host 10. For example, in such access as data reading, data writing, or data erasing, the memory card 1 performs mapping of a logical address to a physical address, ECC error correction, access to a NAND-type flash memory, encryption or decryption of data in a secure region of the NAND-type flash memory, and the like.

The controller 3 includes a memory interface (memory I/F) 4, a host interface (host I/F) 5, a buffer 6, a CPU 7, a read-only memory (ROM) 8, and a random access memory (RAM) 9.

The memory interface 4 performs interface processing between the controller 3 and a NAND-type flash memory 2. The host interface 5 performs interface processing between the controller 3 and the host 10.

In the buffer 6, when data transmitted from the host 10 is written to the NAND-type flash memory 2, a constant amount (for example, one page) of data is temporarily stored, or when data read from the NAND-type flash memory 2 is transmitted to the host 10, the constant amount of data is temporarily stored.

The ROM 8 is a memory in which a control program used by the CPU 7 and the like are stored. The RAM 9 is a volatile memory which is used as a working area of the CPU 7 and in which various kinds of tables and the like are stored.

The CPU 7 controls the operation of the whole memory card 1. In this CPU 7, for example, when the memory card 1 is supplied with power, processing is started according to firmware (control program) stored in the ROM 8. That is, the CPU 7 produces various kinds of tables (management data) necessary for processing on the RAM 9. Further, the CPU 7 receives a write command, a read command, or an erase command from the host 10 to access an appropriate region on the NAND-type flash memory 2, convert a logical address supplied from the host when accessing the NAND-type flash memory 2 into a physical address, or control data transfer processing via the buffer 6.

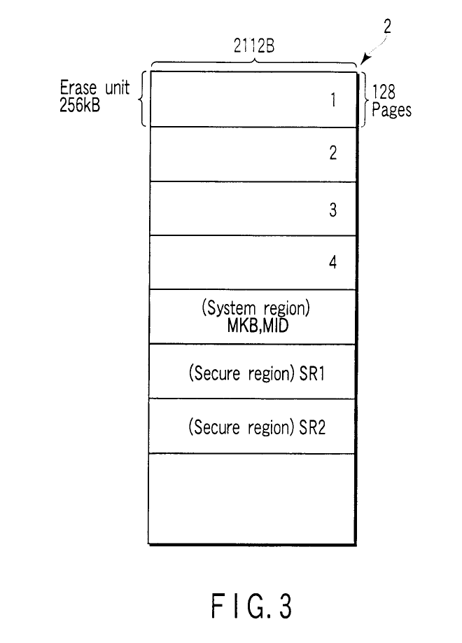

FIG. 3 schematically shows the NAND-type flash memory 2. In the NAND-type flash memory 2, a block size during erasing (erase block size) is set to, for example, 256 Kilobytes, and one page consists of, for example, 2112 bytes (for example, data of 512 bytes×4+a redundant portion of 10 bytes×4+management information of 24 bytes) Therefore, one block consists of, for example, 128 pages. Data writing or reading is performed with respect to each page.

The NAND-type flash memory 2 includes an ordinary data region, a system region, and a secure region. The system region is the region where data for CPU to manage data of NAND type flash memory are stored. A secure region is the region where a host writes in the data which needed security protection at. The ordinary data region is the region where data except data stored in the system region and the secure region are stored by the host. For example an ID inherent to a medium (MID), 16 MKBs, and the like are stored in the system region. Data and MKB IDs to be kept secure and the like are stored in the secure region. The ordinary data region, the system region, and the secure region are assigned to an empty block when blocks are filled so that data is transferred to the empty block. An old block is erased at a predetermined timing to become an empty block.

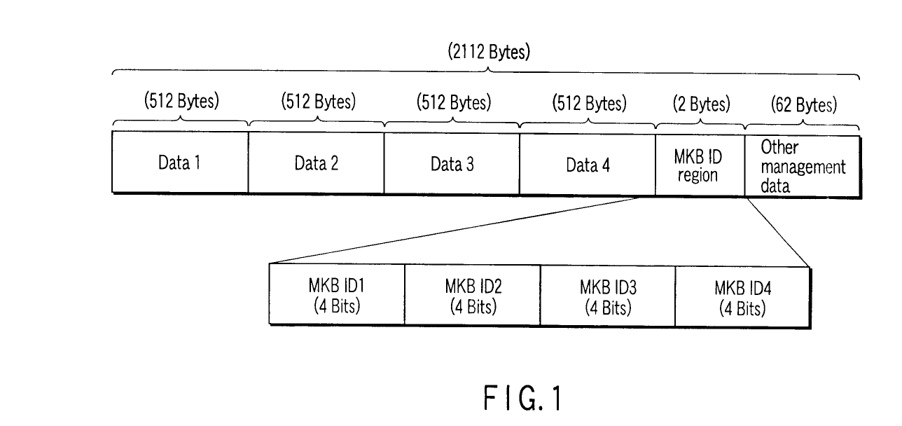

FIG. 1 shows a configuration of one page of the secure region stored in the NAND-type flash memory 2 according to this embodiment. In this embodiment, on one page of the secure region, four data items 1 to 4 are, for example, stored sequentially. Each of data items 1 to 4 consists of 512 bytes. MKB IDs 1 to 4 as identification data items are intensively stored in a specific address within one page. That is, MKB IDs 1 to 4 are stored in an MKB ID region consisting of two bytes and totaling 16 bits. In this MKB ID region, MKB IDs 1 to 4 are stored corresponding to data items 1 to 4 respectively. Each of MKB IDs 1 to 4 consists of four bits. Further, in a remaining region within one page, other management data is stored.

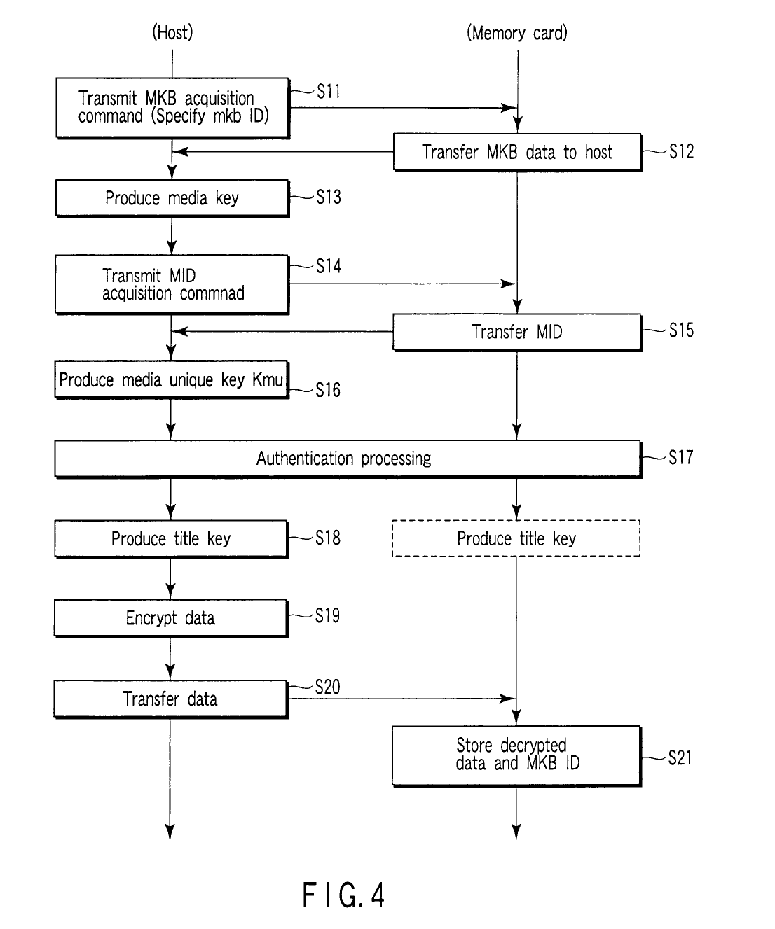

FIG. 4 shows operations of the host 10 and the memory card 1 when the secure region of the memory card 1 is accessed, for example, write operation.

As described above, when the host 10 accesses the secure region of the memory card 1, MKB data is required. For this reason, the host 10 first transfers an MKB acquisition command to the memory card (S11). The MKB acquisition consists of, for example, 48 bits. The command format is as follows. Start bit (one bit)+transmission bit (indicating whether it is a command or a response) (one bit)+command index (indicating a command number) (six bits)+argument (32 bits)+CRC (indicating cyclic redundancy check character) (seven bits)+end bit (one bit). The MKB ID is designated by using, for example, eight bits in argument (32 bits). As described above, the MKB ID is, for example, data of “0” to “15”, and consists of four bits. One of 16 MKB IDs is designated by the MKB acquisition command.

In the memory card 1, MKB ID transferred is stored in the controller 3, for example, the RAM 9 thereof. The controller 3 reads MKB data (for example, data of up to 64 Kilobytes) corresponding to the transferred MKB ID from the system region of the NAND-type flash memory 2 to transfer the same to the host 10 (S12).

The host 10 uses this MKB and a device key which the host 10 includes to produce a media key (S13). Next, the host 10 transfers a command for acquiring an ID inherent to the medium (MID) to the memory card 1 (S14).

According to the command, the memory card 1 transfers MID data of, for example, eight bytes to the host 10 (Sl5). The host 10 produces a media unique key Kmu from this MID and the media key (S16).

Thereafter, between the host 10 and the memory card 1, the media unique key Kmu is used to perform authentication processing based upon a challenge and response protocol (S17). That is, the host 10 transmits data for authentication processing generated by using the media unique key Kmu to the memory card 1, and the memory card 1 verifies received data for authentication processing. The memory card 1 transmits a verification result to a host 10.

When this authentication processing is normally terminated, the host 10 produces a title key based upon the media unique key Kmu and data acquired from the memory card 1 in the authentication processing (S18). At this time, in the memory card 1, similarly, a title key common to the host 10 is also produced. The host 10 encrypts data to be transferred based upon this title key (S19). This encrypted data is transferred from the host 10 to the memory card 1 (S20).

The controller 3 of the memory card 1 decrypts the transferred data based upon the title key produced in the memory card 1, and this decrypted data and the MKB ID corresponding to the preliminarily transferred data are written in the NAND-type flash memory 2 (S21). That is, the controller 3 writes the decrypted data to an empty region in one page of the secure region and writes the MKB ID transferred from the host 10 to the MKB ID region within the same one page.

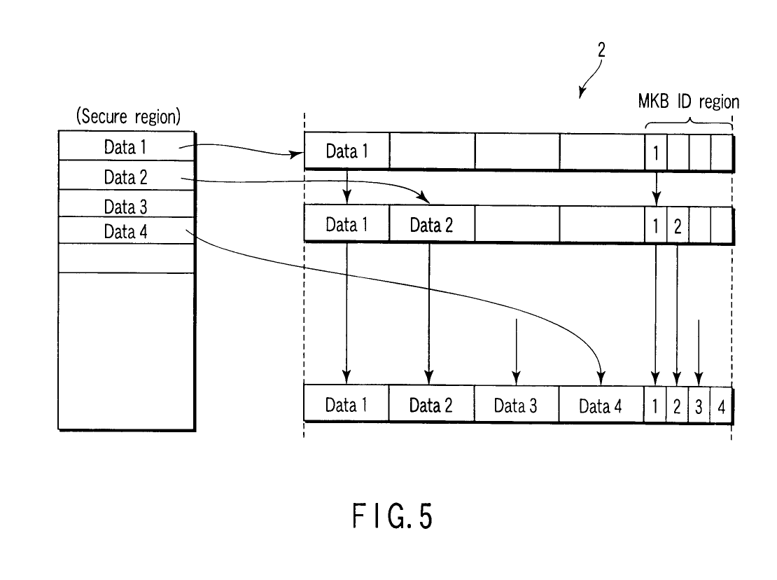

FIG. 5 shows writing operation of the NAND-type flash memory 2. The controller 3 writes the decrypted data to the NAND-type flash memory 2, for example, an empty region of one page within the secure region SR1 thereof. Herewith, the controller 3 writes the four-bit MKB ID transferred by an MKB ID acquisition command to a corresponding region in the MKB ID region. That is, when an MKB ID is “1” at a write time of data 1, the data 1 is written to an empty region within one page, and MKB ID=“1” is written in a corresponding position in the MKB ID region.

Next, for example, when the data 2 and MKB ID=“2” stored in the secure region of the host 10 are written, operation shown in FIG. 4 is performed, and the controller 3 of the memory card 1 writes the transferred data 2 in an empty region within one page of the secure region SR1 of the NAND-type flash memory 2. Herewith, the MKB ID=“2” is written in a corresponding position in the MKB ID region. This writing operation is similar to ordinary write-once read-many writing. That is, for example, the written data 1 and the written MKB ID=“1” are first read, and this data 1, the data 2 to be additionally written as the MKB ID=“1” and the MKB ID=“2” are written in another empty page within the secure region SR1. Such operations are sequentially performed according to write data.

Further, when the data written in the above manner is read, common title keys in the memory card 1 and the host 10 are produced according to such operations as steps S11 to S18 shown in FIG. 4. Thereafter, for example, when data item 1 is read, data item 1 corresponding to the MKB ID=“1” supplied to the memory card 1 from the host 10 is read at a reading time according to step S11. This read data is encrypted by the title key to be transferred to the host.

Further, when the MKB ID=“2” is supplied from the host 10 to the memory card 1 at a reading time of data item 1 stored in the memory card 1, the MKB ID=“2” is inconsistent with the MKB ID=“1” stored in the MKB ID region corresponding to data item 1 of the memory card 1. In this case, all “1” data is transferred to the host 10 from the memory card 1 to protect data from unauthorized access.

According to the above-described embodiment, to a plurality of data items stored in one page of the secure region of the NAND-type flash memory 2, a plurality of MKB IDs corresponding to this data is stored intensively in one MKB ID region. Besides, each of the MKB IDs stored in this MKB ID region is comprised of four bits required for storing one of 16 MKB IDs. Therefore, the MKB ID region can be reduced as compared with a conventional art.

Incidentally, the above-described embodiment has shown a case in which the present invention is applied to a memory card as a storage device. However, it is obvious that the present invention is not limited to the memory card and can be applied to a device which handles this kind of encrypted data.

Further, in FIG. 1, a plurality of data items 1 to 4 can be sequentially stored within one page, but not limited thereto, other management data can also be stored between data and data.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A storage device comprising:
a secure region including a plurality of pages, wherein each of the plurality of pages includes a first storage region in which a plurality of data items is stored, and a second storage region in which a plurality of identification data items corresponding respectively to the plurality of data items is stored.

2. The device according to claim 1,
wherein each of the plurality of identification data items is data for identifying key data for generating each of the data items.

3. The device according to claim 1,
wherein the storage device is a NAND-type flash memory.

4. The device according to claim 3,
wherein the NAND-type flash memory comprises:
at least one of the secure region;
a system region; and
a plurality of data storage regions.

5. A storage device comprising:
a storage unit including a secure region in which a plurality of data items is stored, the secure region comprised of a plurality of pages; and
a controller which causes one of the pages to store a plurality of data items, the controller causing a specific region of the page to store a plurality of identification data items corresponding respectively to the plurality of data items.

6. The device according to claim 5,
wherein each of the plurality of identification data items is data for identifying key data for generating each data item.

7. The device according to claim 6,
wherein the key data is a media key block (MKB), and the identification data is the identification data for identifying the MKB.

8. The device according to claim 5,
wherein, when first data is written in a first page, the controller writes first identification data corresponding to the first data in a specific region of the first page.

9. The device according to claim 8,
wherein, second data is written in the first page, the controller assigns a second page, writes the first data of the first page and the second data in the second page, and writes the first identification data of the specific region of the first page and second identification data in a specific region of the second page.

10. The device according to claim 5,
wherein the storage unit is a NAND-type flash memory.

11. The device according to claim 5,
wherein the storage device is a memory card.

12. The device according to claim 11, further comprising
a host device which controls the memory card,
wherein the host device
transmits the identification data to the memory card,
receives key data corresponding to the identification data transmitted from the memory card,
produces a media key based upon the key data and a device key,
receives identification data inherent to the memory card transmitted from the memory card,
produces a media unique key by using the media key and the identification data inherent to the memory card,
performs authentication processing by using the media unique key,
produces a title key based upon data acquired from the memory card when the authentication processing is normally completed,
encrypts the first data and the first identification data to be transmitted based upon the title key, and
transmits the encrypted data to the memory card.

13. The device according to claim 12,
wherein the controller of the memory card
receives the encrypted data transmitted from the host device,
decrypts the encrypted data by using the title key produced in the memory card, and
writes the decrypted first data in the first page, and writes the first identification data in the specific region of the first page.

14. A control method of a storage device comprising:
storing a plurality of data items in a first page of a secure region of a storage unit, and
storing a plurality of identification data items corresponding respectively to the plurality of data items in a specific region of the first page.

15. The method according to claim 14,
wherein each of the plurality of identification data items is data for identifying key data for generating each data item.

16. The method according to claim 15,
wherein the key data is a media key block (MKB), and the identification data is identification data for identifying the MKB.

17. The method according to claim 14,
wherein the storage device is a memory card.

18. The method according to claim 17, further comprising
a host device which controls the memory card,
wherein the host device
transmits the identification data to the memory card,
receives key data corresponding to the identification data transmitted from the memory card,
produces a media key based upon the key data and a device key,
receives identification data inherent to the memory card transmitted from the memory card,
produces a media unique key by using the media key and the identification data inherent to the memory card,
performs authentication processing by using the media unique key,
produces a title key based upon data acquired from the memory card when the authentication processing is normally terminated,
encrypts the first data and the first identification data to be transmitted based upon the title key, and
transmits the encrypted data to the memory card.

19. The method according to claim 18,
wherein the controller of the memory card
receives the encrypted data transmitted from the host device,
decrypts the encrypted data by using the title key produced in the memory card, and
writes the decrypted first data in the first page, and writes the decrypted identification data in the specific region of the first page.
